(19) United States
(12) Patent Application Publication
(10) Pub. No.: US 2015/0134420 A1
(43) Pub. Date: May 14, 2015

(54) METHOD AND SYSTEM FOR PROVIDING MERCHANT RECOMMENDATION DATA USING TRANSACTION DATA

(71) Applicant: MasterCard International Incorporated, Purchase, NY (US)

(72) Inventors: Kenny Unser, Fairfield, CT (US); Nikhil Malgatti, Stamford, CT (US); Serge Bernard, Danbury, CT (US)

(73) Assignee: MasterCard International Incorporated, Purchase, NY (US)

(21) Appl. No.: 14/080,449

(22) Filed: Nov. 14, 2013

(51) Int. Cl. G06Q 30/02

(52) U.S. Cl. CPC G06Q 30/0205
USPC 705/7.34

(57) ABSTRACT

A computer-implemented method for providing merchant recommendation data based on candidate merchant input data is provided. The method is implemented using a computing device in communication with a memory. The method includes storing transaction data for a plurality of model merchants within the memory, storing model merchant data for each of the plurality of model merchants within the memory, wherein the model merchant data includes geographic attributes associated with each of the model merchants, generating a location model by comparing the transaction data for each model merchant and the model merchant data for each model merchant, receiving candidate merchant input data for a candidate merchant, and providing, based on the location model and the candidate merchant input data, merchant recommendation data for the candidate merchant, wherein the merchant recommendation data includes at least one of a recommended merchant location and a recommended merchant type.

### BACKGROUND

This description relates to commercial real estate, and more particularly, to recommending a merchant type for a candidate merchant location or a merchant location for a candidate merchant type, based on transaction data associated with at least one known merchant.

The financial success of a merchant affects the merchant's ability to pay rent to the owner of a commercial property location in which the merchant is located. Accordingly, an owner of a commercial property location may wish to know what type or types of merchants would be most successful in the commercial property location. Such knowledge would allow the owner of the commercial property location to make informed decisions about modifying the commercial property location to accommodate merchants that would be most successful in the location and to market the location to such merchants. Likewise, a merchant interested in conducting business in a new location may wish to understand which locations would aid in the financial success (e.g., revenue) of their business. Similarly, a merchant may wish to understand what type of business the merchant should conduct in a particular location in order to increase the merchant's likelihood of financial success. Accordingly, it would be beneficial to have a system that recommends a type of business (“merchant type”) or a commercial property location (“merchant location”) for a candidate merchant based at least in part on data pertaining to payment card transactions associated with at least one existing (“model”) merchant and attributes of the location where the at least one model merchant is conducting business.

### BRIEF DESCRIPTION OF THE DISCLOSURE

In one aspect, a computer-implemented method for providing merchant recommendation data based on candidate merchant input data is provided. The method is implemented using a computing device in communication with a memory. The method includes storing transaction data for a plurality of model merchants within the memory, storing model merchant data for each of the plurality of model merchants within the memory, wherein the model merchant data includes geographic attributes associated with each of the model merchants, generating a location model by comparing the transaction data for each model merchant and the model merchant data for each model merchant, receiving candidate merchant input data for a candidate merchant, and providing, based on the location model and the candidate merchant input data, merchant recommendation data for the candidate merchant, wherein the merchant recommendation data includes at least one of a recommended merchant location and a recommended merchant type.

In another aspect, a computing device for providing merchant recommendation data based on candidate merchant input data is provided. The computing device includes a memory device and a processor coupled to the memory device. The computing device is configured to store transaction data for a plurality of model merchants within the memory, store model merchant data for each of the plurality of model merchants within the memory, wherein the model merchant data includes geographic attributes associated with each of the model merchants, generate a location model by comparing the transaction data for each model merchant and the model merchant data for each model merchant, receive candidate merchant input data for a candidate merchant, and provide, based on the location model and the candidate merchant input data, merchant recommendation data for the candidate merchant, wherein the merchant recommendation data includes at least one of a recommended merchant location and a recommended merchant type.

In yet another aspect, a computer-readable storage medium having computer-executable instructions embodied thereon is provided. When executed by a computing device having at least one processor in communication with a memory, the computer-executable instructions cause the computing device to store transaction data for a plurality of model merchants within the memory, store model merchant data for each of the plurality of model merchants within the memory, wherein the model merchant data includes geographic attributes associated with each of the model merchants, generate a location model by comparing the transaction data for each model merchant and the model merchant data for each model merchant, receive candidate merchant input data for a candidate merchant, and provide, based on the location model and the candidate merchant input data, merchant recommendation data for the candidate merchant, wherein the merchant recommendation data includes at least one of a recommended merchant location and a recommended merchant type.

### BRIEF DESCRIPTION OF THE DRAWINGS

FIGS. 1-9 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example merchant location system including a plurality of computing devices in accordance with one example embodiment of the present disclosure.

FIG. 3 is an expanded block diagram of an example embodiment of a server architecture of the merchant location system including the plurality of computing devices in accordance with one example embodiment of the present disclosure.

FIG. 4 illustrates an example configuration of a client system shown in FIGS. 2 and 3.

FIG. 5 illustrates an example configuration of a server system shown in FIGS. 2 and 3.

FIG. 6 is a block diagram of an example geographic region in which model merchants conduct business.

FIG. 7 is a block diagram of an example geographic region including a commercial property location in which a candidate merchant may conduct business.

FIG. 8 is a flowchart of an example process that may be performed by the merchant location system of FIGS. 2 and 3 for providing merchant recommendation data based on candidate merchant input data.

FIG. 9 is a diagram of components of one or more example computing devices that may be used in the merchant location system shown in FIGS. 2 and 3.

### DETAILED DESCRIPTION OF THE DISCLOSURE

Systems and methods described herein utilize payment card transaction data (“transaction data”) as a comparative measure to provide merchant recommendation data based on candidate merchant input data, wherein merchant recommendation data includes a merchant type or a merchant location, and candidate merchant input data includes a candidate merchant location or a candidate merchant type. More specifically, the systems and methods described herein identify (i) a type of merchant for a specified geographic region or a specified commercial property location, or (ii) a commercial property location for a specified type of merchant. An implementation of the systems described herein may be referred to as a merchant location system (“ML system”). Various different geographic regions are analyzed by the ML system to determine attributes that contribute to the success (e.g., revenue) of merchants located in the regions. More specifically, the ML system described herein collects transaction data for merchants located in various geographic regions. These merchants are referred to as model merchants. The transaction data is collected by the ML system from a payment network that processes payment card transactions for the model merchants.

In addition to the transaction data, the ML system may also collect various geographic attributes associated with each model merchant, demographic attributes associated with a region where each model merchant is located, and/or cardholder attributes associated with cardholders that transact with each model merchant. The ML system may compare the transaction data and these attributes to generate a location model.

In some implementations, the ML system uses the location model to identify a recommended merchant type for a specified location based on model merchants located at, or near, the specified location, or in a location that has similar attributes to the specified location. More specifically, the recommended merchant type has similar attributes to a certain model merchant whose transaction data indicate increased revenue, increased transaction volume, or other indicators of financial success, when compared to other model merchants. When the ML system receives a candidate merchant location associated with a candidate merchant, the candidate merchant location is input to the location model. The ML system then identifies, using the location model, the recommended merchant type for the candidate merchant based on the candidate merchant location.

In other implementations, the ML system uses the location model to identify a recommended merchant location for a specified merchant type. The recommended merchant location is determined based on the locations of model merchants of the specified merchant type. More specifically, the ML system identifies a recommended merchant location based on the locations of model merchants of the specified merchant type whose transaction data indicate increased revenue, increased transaction volume, or other indicators of financial success, when compared to other model merchants of the specified merchant type. When the ML system receives a candidate merchant type associated with a candidate merchant, the candidate merchant type is input to the location model. The ML system then identifies, using the location model, the recommended merchant location for the candidate merchant based on the candidate merchant type.

The methods and systems described herein may be implemented using computer programming or engineering techniques including computer software, firmware, hardware or any combination or subset thereof, wherein the technical effect may include at least one of: (a) storing transaction data for a plurality of model merchants within a memory; (b) storing model merchant data for each of the plurality of model merchants within the memory, wherein the model merchant data includes geographic attributes associated with each of the model merchants; (c) generating a location model by comparing the transaction data for each model merchant and the model merchant data for each model merchant; (d) receiving candidate merchant input data for a candidate merchant; and (e) providing, based on the location model and the candidate merchant input data, merchant recommendation data for the candidate merchant, wherein the merchant recommendation data includes at least one of a recommended merchant location and a recommended merchant type.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transaction card can be used as a method of payment for performing a transaction.

In one embodiment, a computer program is provided, and the program is embodied on a computer-readable medium. In an example embodiment, the system is executed on a single computer system, without requiring a connection to a sever computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

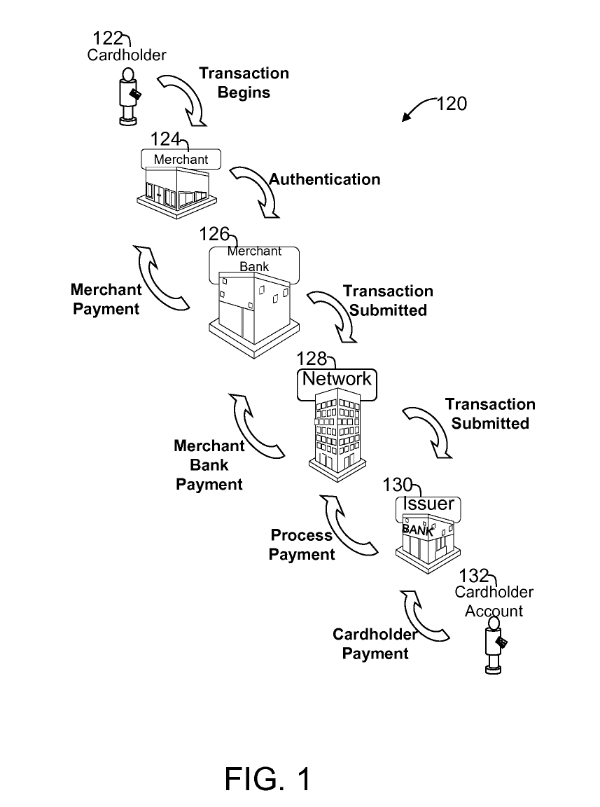

FIG. 1 is a schematic diagram illustrating an example multi-party payment card system 120 for enabling ordinary payment-by-card transactions in which merchants and card issuers do not necessarily have a one-to-one relationship. The present disclosure relates to payment card system 120, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 120, a financial institution such as an issuer 130 issues a payment account card, such as a credit card account or a debit card account, to a cardholder 122, who uses the payment account card to tender payment for a purchase from a merchant 124. To accept payment with the payment account card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment account card (also known as a financial transaction card), merchant 124 requests authorization from acquirer 126 for the amount of the purchase. The request may be performed over the telephone, but is usually performed through the use of a point-of-interaction terminal, which reads the cardholder's account information from the magnetic stripe on the payment account card and communicates electronically with the transaction processing computers of acquirer 126. Alternatively, acquirer 126 may authorize a third party to perform transaction processing on its behalf In this case, the point-of-interaction terminal will be configured to communicate with the third party. Such a third party is usually called a “merchant processor” or an “acquiring processor.”

Using payment card system payment network 128, the computers of acquirer 126 or the merchant processor will communicate with the computers of issuer 130, to determine whether the cardholder's account 132 is in good standing and whether the purchase is covered by the cardholder's available credit line or account balance. Based on these determinations, the request for authorization will be declined or accepted. If the request is accepted, an authorization code is issued to merchant 124.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 124 captures the transaction by, for example, appropriate data entry procedures on the point-of-interaction terminal If a cardholder cancels a transaction before it is captured, a “void” is generated. If a cardholder returns goods after the transaction has been captured, a “credit” is generated.

For debit card transactions, when a request for authorization is approved by the issuer, the cardholder's account 132 is decreased. Normally, a charge is posted immediately to cardholder's account 132. The bankcard association then transmits the approval to the acquiring processor for distribution of goods/services, or information or cash in the case of an ATM.

After a transaction is captured, the transaction is settled between merchant 124, acquirer 126, and issuer 130. Settlement refers to the transfer of financial data or funds between the merchant's account, acquirer 126, and issuer 130 related to the transaction. Usually, transactions are captured and accumulated into a “batch,” which is settled as a group.

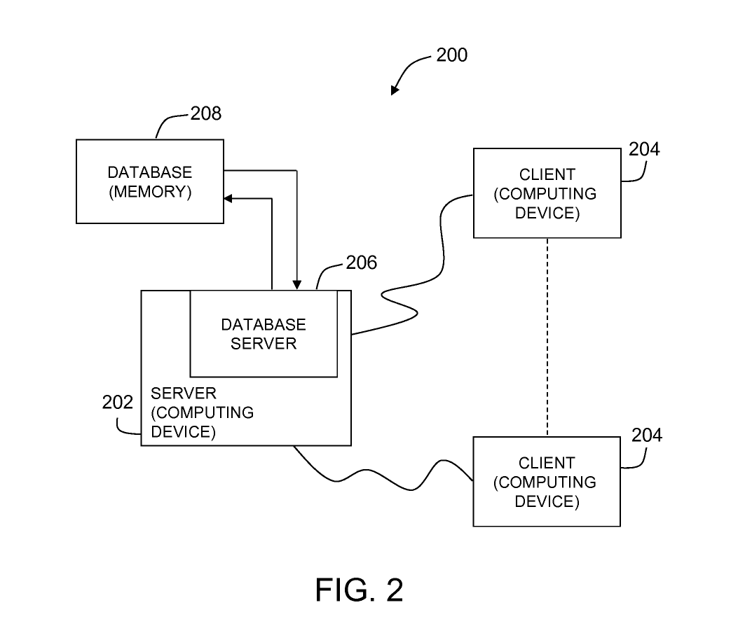

FIG. 2 is a simplified block diagram of an example merchant location system (“ML system”) 200 in accordance with one embodiment of the present disclosure. In the example embodiment, system 200 includes a server system 202 and a plurality of client subsystems, also referred to as client systems 204 or client computing devices, connected to server system 202. In one embodiment, client systems 204 are computers including a web browser, such that server system 202 is accessible to client systems 204 using the Internet. Client systems 204 are interconnected to the Internet through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), or other web-connectable equipment. A database server 206 is connected to a database 208 containing information on a variety of matters, as described below in greater detail. In one embodiment, database 208 is stored on server system 202 and may be accessed by potential users at one of client systems 204 by logging onto server system 202 through one of client systems 204. In any alternative embodiment, database 208 is stored remotely from server system 202 and may be non-centralized. Server system 202 could be any type of computing device configured to perform the steps described herein.

As discussed below, payment card transaction data (“transaction data”) from merchants, including merchant account numbers, merchant locations, merchant names, transaction amounts, and transaction dates, is stored within database 208. In addition, model merchant data, including merchant types (e.g., merchant type classification codes), geographic information, demographic information, and attributes of cardholders who have purchased goods or services from the merchants are stored in database 208. Further, a location model is stored within database 208.

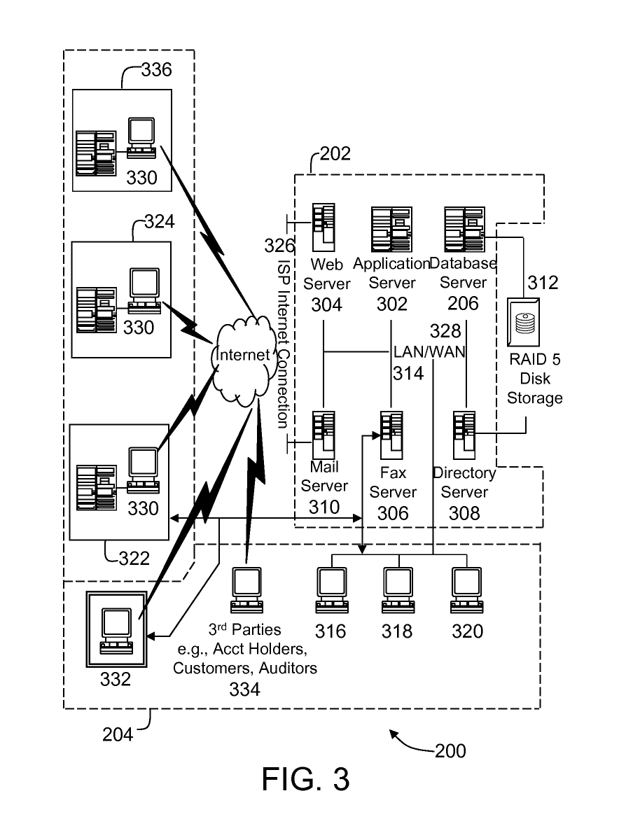

FIG. 3 is an expanded block diagram of an example embodiment of a server architecture of merchant location system 200 in accordance with one embodiment of the present disclosure. Merchant location system 200 includes server system 202 and client systems 204. Server system 202 further includes database server 206, an application server 302, a web server 304, a fax server 306, a directory server 308, and a mail server 310. A disk storage unit 312 is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 202 is configured to be communicatively coupled to various entities, including acquirers 322 and issuers 324, and to third parties, e.g., auditors, 334 using an Internet connection 326. Server system 202 is also communicatively coupled with a merchant 336. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the example embodiment, any authorized individual or entity having a workstation 330 may access system 200. At least one of the client systems includes a manager workstation 332 located at a remote location. Workstations 330 and 332 include personal computers having a web browser. Also, workstations 330 and 332 are configured to communicate with server system 202. Furthermore, fax server 306 communicates with remotely located client systems, including a client system 332, using a telephone link. Fax server 306 is configured to communicate with other client systems 316, 318, and 320 as well.

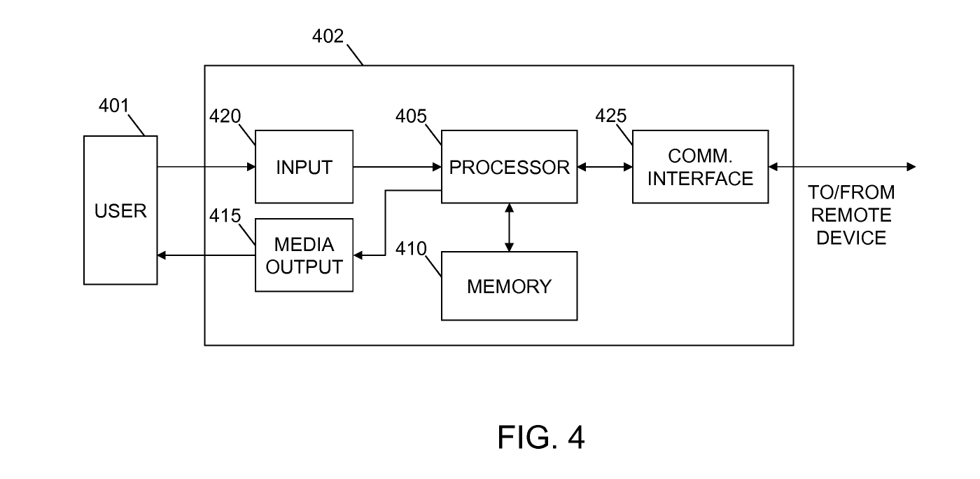

FIG. 4 illustrates an example configuration of a cardholder computing device 402 operated by a cardholder 401. Cardholder computing device 402 may include, but is not limited to, client systems (“client computing devices”) 204, 316, 318, and 320, workstation 330, and manager workstation 332 (shown in FIG. 3).

Cardholder computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

Cardholder computing device 402 also includes at least one media output component 415 for presenting information to cardholder 401. Media output component 415 is any component capable of conveying information to cardholder 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computing device 402 includes an input device 420 for receiving input from cardholder 401. Input device 420 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 415 and input device 420.

Cardholder computing device 402 may also include a communication interface 425, which is communicatively couplable to a remote device such as server system 202 or a web server operated by a merchant. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer-readable instructions for providing a user interface to cardholder 401 via media output component 415 and, optionally, receiving and processing input from input device 420. A user interface may include, among other possibilities, a web browser and client application. Web browsers enable cardholders, such as cardholder 401, to display and interact with media and other information typically embedded on a web page or a website from server system 202 or a web server associated with a merchant. A client application allows cardholder 401 to interact with a server application from server system 202 or a web server associated with a merchant.

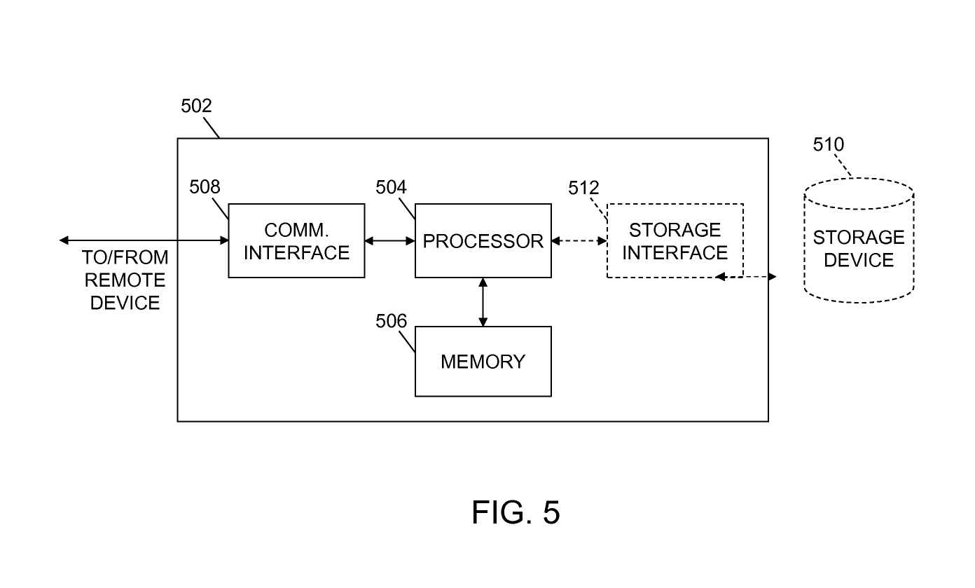

FIG. 5 illustrates an example configuration of a server computing device 502 (“merchant location computing device”) such as server system 202 (shown in FIGS. 2 and 3). Server computing device 502 may include, but is not limited to, database server 206, application server 302, web server 304, fax server 306, directory server 308, and mail server 310.

Server computing device 502 includes a processor 504 for executing instructions. Instructions may be stored in a memory area 506, for example. Processor 504 may include one or more processing units (e.g., in a multi-core configuration).

Processor 504 is operatively coupled to a communication interface 508 such that server computing device 502 is capable of communicating with a remote device such as cardholder computing device 402 or another server computing device 502. For example, communication interface 508 may receive requests from client systems 204 via the Internet, as illustrated in FIGS. 2 and 3.

Processor 504 may also be operatively coupled to a storage device 510. Storage device 510 is any computer-operated hardware suitable for storing and/or retrieving data. In some embodiments, storage device 510 is integrated in server computing device 502. For example, server computing device 502 may include one or more hard disk drives as storage device 510. In other embodiments, storage device 510 is external to server computing device 502 and may be accessed by a plurality of server computing devices 502. For example, storage device 510 may include multiple storage units such as hard disks or solid state disks in a redundant array of inexpensive disks (RAID) configuration. Storage device 510 may include a storage area network (SAN) and/or a network attached storage (NAS) system.

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory areas 410 and 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

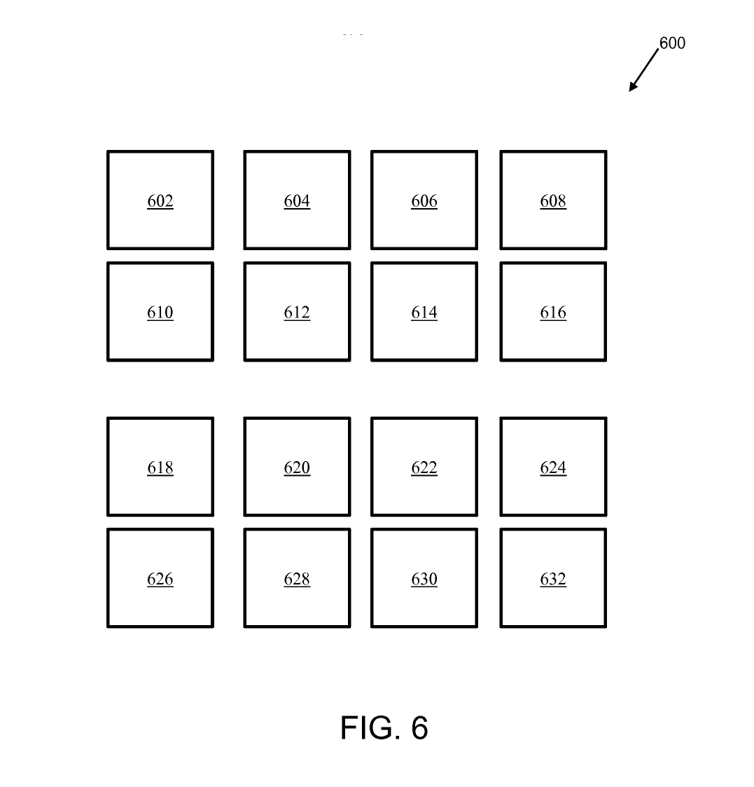

FIG. 6 is a block diagram of an example geographic region 600 in which a plurality of model merchants 602, 604, 606, 608, 610, 612, 614, 616, 618, 620, 622, 624, 626, 628, 630, and 632 conduct business. Each of model merchants 602, 604, 606, 608, 610, 612, 614, 616, 618, 620, 622, 624, 626, 628, 630, and 632 receive payments from cardholders 122 and process the payments through payment network 128. Accordingly, database 208 contains transaction data for each of model merchants 602, 604, 606, 608, 610, 612, 614, 616, 618, 620, 622, 624, 626, 628, 630, and 632. Descriptions or codes associated with goods and services sold by model merchants 602, 604, 606, 608, 610, 612, 614, 616, 618, 620, 622, 624, 626, 628, 630, and 632 may be included in authorization request messages transmitted from model merchants 602, 604, 606, 608, 610, 612, 614, 616, 618, 620, 622, 624, 626, 628, 630, and 632 to payment network 128 when processing payments from cardholders 122. Based on the goods and/or services sold by each of model merchants 602, 604, 606, 608, 610, 612, 614, 616, 618, 620, 622, 624, 626, 628, 630, and 632, merchant location system 200 may associate each of model merchants 602, 604, 606, 608, 610, 612, 614, 616, 618, 620, 622, 624, 626, 628, 630, and 632 with one or more merchant types.

A merchant type may, for example, be a restaurant, a movie theater, a car dealership, or a sporting goods store or the like. Additionally, the merchant types may be defined more specifically, and differentiate between different levels of quality or prices associated with good or services provided by a merchant. For example, restaurants may be further divided into low-price restaurants (e.g., fast food restaurants) and higher-priced restaurants (e.g., steak houses). Additionally, each merchant type may be associated with a classification code, such as a merchant category code (MCC), a North American Industry Classification System (NAICS) code, or other sequence of number and/or letters that corresponds to a merchant type. Database 208 may store, as model merchant data, merchant types and/or merchant category codes associated with each model merchant 602, 604, 606, 608, 610, 612, 614, 616, 618, 620, 622, 624, 626, 628, 630, and 632.

Region 600 has certain demographics. For example, model merchant 602 may be a medical facility, such as a hospital. Accordingly, model merchants 604, 606, 608, 610, 612, 614, 616, 618, 620, 622, 624, 626, 628, 630, and 632 may sell goods and services that cater to doctors or other relatively high income individuals. For example, model merchant 604 may be a luxury car dealership, model merchant 606 may be a golf store, and model merchant 608 may be a relatively high-priced restaurant. Merchant location system 200 may store, in database 208, such demographic information in association with each of model merchants 602, 604, 606, 608, 610, 612, 614, 616, 618, 620, 622, 624, 626, 628, 630, and 632 as model merchant data.

Additionally, merchant location system 200 may store, as model merchant data in database 208, cardholder attributes associated with each model merchant 602, 604, 606, 608, 610, 612, 614, 616, 618, 620, 622, 624, 626, 628, 630, and 632. For example, merchant location system 200 may determine, based on a name, address, and/or account number information of cardholders purchasing goods or services at one of model merchants 602, 604, 606, 608, 610, 612, 614, 616, 618, 620, 622, 624, 626, 628, 630, and 632, whether the cardholders are repeat customers, and/or whether the cardholders are local to the model merchants 602, 604, 606, 608, 610, 612, 614, 616, 618, 620, 622, 624, 626, 628, 630, and 632. For example, if a merchant is located along a highway, many customers (cardholders) associated with transactions processed by the merchant may not be repeat customers and/or may not be local to the merchant.

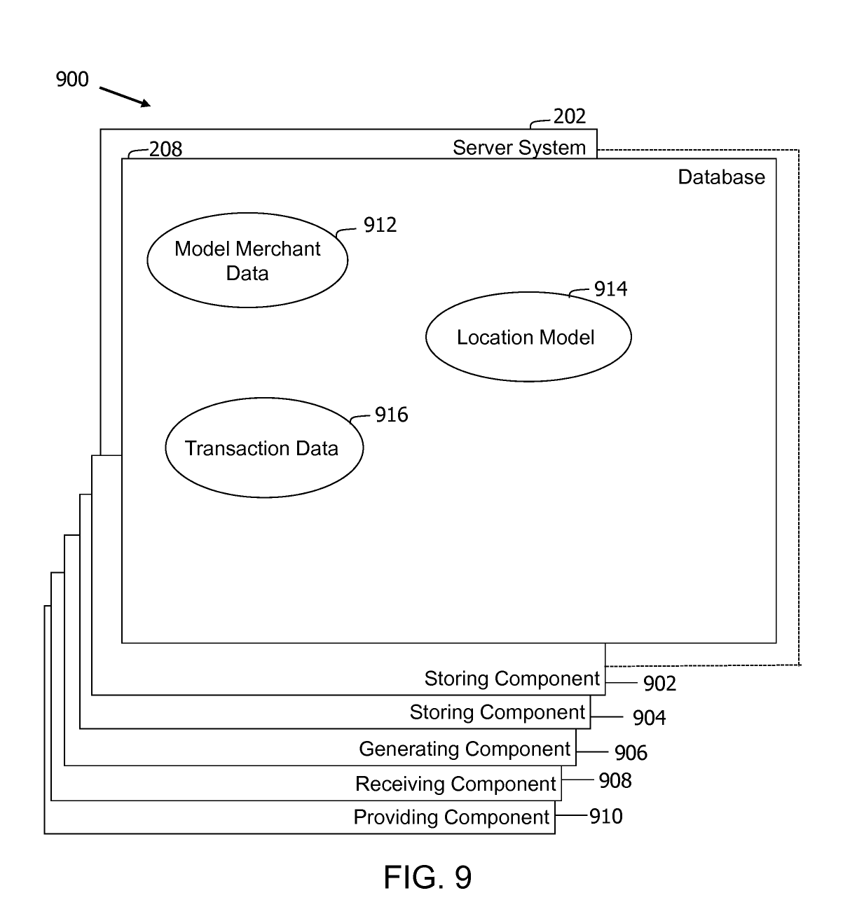

Based on transaction data stored in database 208 for model merchants 602, 604, 606, 608, 610, 612, 614, 616, 618, 620, 622, 624, 626, 628, 630, and 632, merchant location system 200 may determine a transaction velocity (i.e., rate), revenue, or other measure of financial success for each model merchant. Merchant location system 200 may determine, based on their respective transaction data, that one or more of model merchants 602, 604, 606, 608, 610, 612, 614, 616, 618, 620, 622, 624, 626, 628, 630, and 632 is more financially successful than one or more model merchants of the same type in a different geographic region. By generating a location model 914 (FIG. 9) that relates and compares transaction data with model merchant data, merchant location system 200 may determine which attributes or combinations of attributes (e.g., geographic attributes, demographic attributes, and/or cardholder (customer) attributes) are statistically correlated with financial success for merchants of different types.

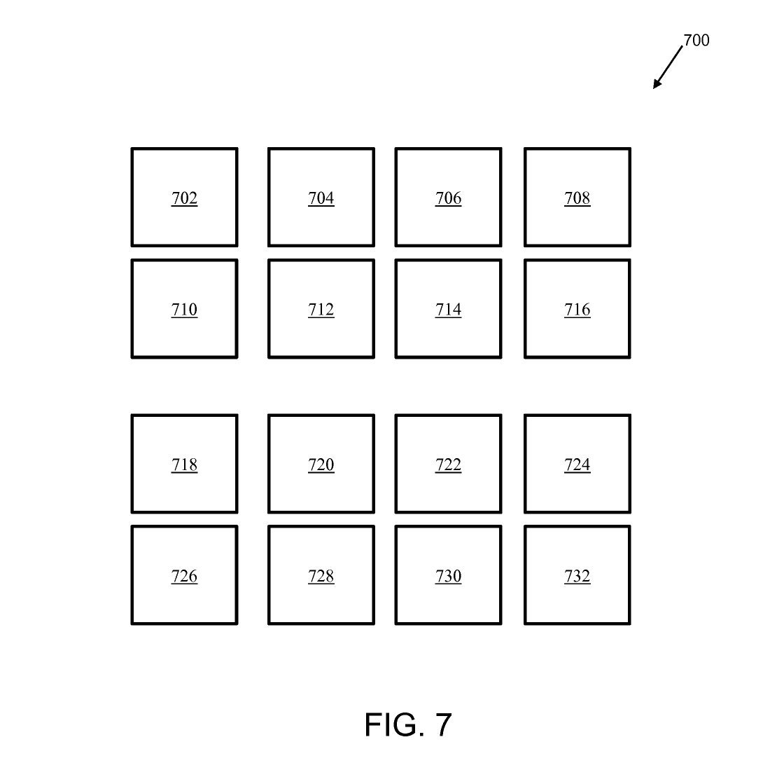

FIG. 7 is a block diagram of an example geographic region 700 including a commercial property location 702 in which a candidate merchant 124 may conduct business. Geographic region 700 includes a plurality of model merchants 704, 706, 708, 710, 712, 714, 716, 718, 720, 722, 724, 726, 728, 730, and 732. Based on transaction data and model merchant data stored in database 208 in association with each model merchant in geographic region 700, merchant location system 200 may determine that geographic region 700 is similar to geographic region 600 in that both regions 600 and 700 have similar demographics, merchant types, and customers (cardholders). Accordingly, merchant location system 200 may determine that candidate merchant 124 should sell products or services that are not already sold in region 700, but which would likely sell well based on a transaction volume of a similar merchant in region 600. For example, region 700 may not already include a luxury car dealership. Accordingly, merchant location system 200 may identify a luxury car dealership as a merchant type that candidate merchant 124 should be, in order to have a relatively high likelihood of success in region 700.

In making the above-described identification, merchant location system 200 may determine a market opportunity value. For example, the market opportunity value may be a number between 1 and 10 that represents a confidence level that an identified merchant type at location 702 would receive revenue greater than or equal to a predetermined value. In other implementations, the market opportunity value may be an estimated revenue (e.g., a monthly or yearly revenue). The market opportunity value may be based on transaction data and model merchant data associated with one or more similarly situated model merchants, for example model merchant 604. Merchant location system 200 may also determine a market saturation value. The market saturation value may be, for example, a number between 1 and 10 that represents how saturated region 700 is with respect to merchants of a particular type. For example, if two or more of model merchants 704, 706, 708, 710, 712, 714, 716, 718, 720, 722, 724, 726, 728, 730, and 732 is a golf store, then merchant location system 200 may generate a market saturation value closer to 10 than to 1, to indicate that region 700 is likely saturated with merchants that sell golf supplies. Accordingly, given a high market saturation value for a specific merchant type in region 700, merchant location system 200 may determine that an additional merchant of that type would not be likely to succeed in region 700. In some implementations, merchant location system 200 may set the market saturation value equal to the number of merchants of a particular type in region 700 and divide the market opportunity value by the market saturation value.

Merchant location system 200 may additionally or alternatively identify a recommended merchant location for a candidate merchant of a given type. For example, using the data described above, merchant location system 200 may determine that, given that candidate merchant 124 plans to sell luxury cars, a location that would provide a relatively high likelihood of success (e.g., a market opportunity value above a predetermined value such as 8) is location 702. In some implementations, merchant location system 200 identifies an exact address, for example a street address of location 702. In other implementations, merchant location 200 identifies a region, such as region 700 for candidate merchant 124 to operate in. Merchant location system 200 may perform the above functions by generating and utilizing a location model that relates transaction data and model merchant data, as described herein.

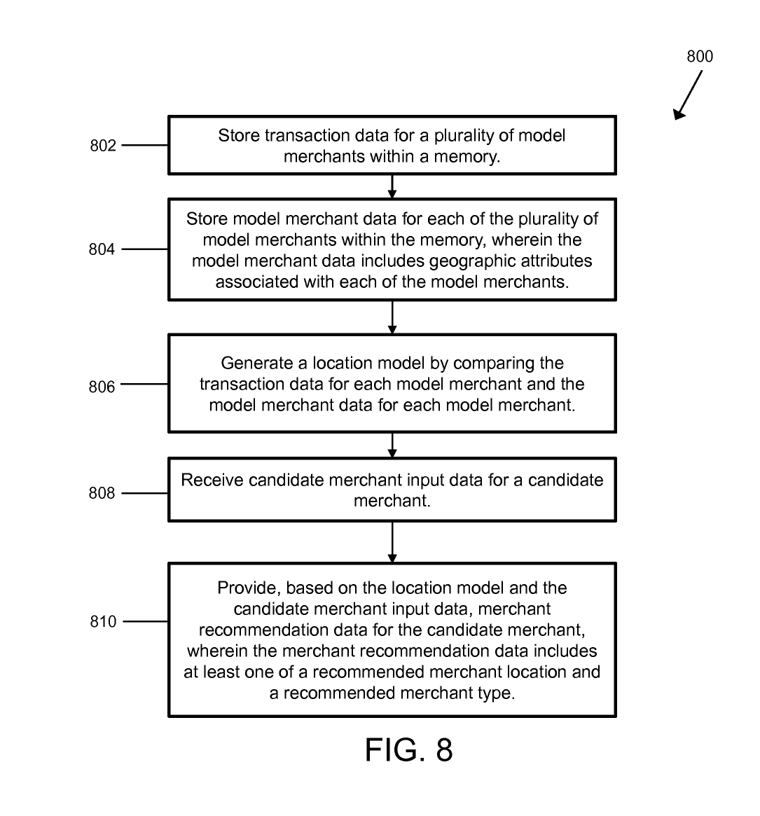

FIG. 8 is a flowchart of an example process 800 for providing merchant recommendation data based on candidate merchant input data. Process 800 may be performed by merchant location system 200. Initially, server system (“merchant location computing device”) 202 stores 802 transaction data for a plurality of model merchants (e.g., model merchants 602, 604, 606, 608, 610, 612, 614, 616, 618, 620, 622, 624, 626, 628, 630, 632, 704, 706, 708, 710, 712, 714, 716, 718, 720, 722, 724, 726, 728, 730, and 732) within a memory, for example database 208. Additionally, server system 202 stores 804 model merchant data for each of the plurality of model merchants within the memory (e.g., database 208). The model merchant data includes geographic attributes associated with each of the model merchants. For example, the geographic attributes may include an address of each model merchant and/or an indication of a region (e.g., region 600) in which each model merchant is located. Additionally, the model merchant data may include demographic information associated with each model merchant. The demographic information may include, for example, information on goods and services sold to customers (cardholders) by model merchants within a predetermined distance of a model merchant (e.g., region 600). Additionally, the model merchant data may include attributes pertaining to customers (cardholders) who purchase goods and/or services from each model merchant. For example, the attributes may include information pertaining to how many and/or what percentage of customers are local to each model merchant and/or whether how many and/or what percentage of customers are repeat customers of each model merchant. In some implementations, in storing model merchant data, server system 202 associates a merchant type classification code with each model merchant.

Additionally, server system 202 generates 806 a location model 914 (FIG. 9) by comparing the transaction data for each model merchant and the model merchant data for each model merchant. Server system 202 may store location model 914 in database 208. In some implementations, generating location model 914 includes generating the location model for each model merchant associated with one or more specified geographic attributes (e.g., a geographic region, such as a neighborhood, city, state, or country). In some implementations, generating the location model includes generating the location model for each model merchant associated with at least one specified merchant type classification code.

Additionally, server system 202 receives 808 candidate merchant input data for a candidate merchant. For example, server system 202 may receive candidate merchant input data from a client computing device 204 communicatively coupled to server system 202. For example, the candidate merchant input data may specify a candidate merchant type (i.e., a proposed type of goods and/or services to be sold by the candidate merchant). In other instances, the candidate merchant input data may specify a candidate merchant location (i.e., a proposed location in which the candidate merchant will conduct business). Additionally, server system 202 provides, based on the location model and the candidate merchant input data, merchant recommendation data for the candidate merchant. The merchant recommendation data includes at least one of a recommended merchant location and a recommended merchant type. For example, if the candidate merchant input data specifies a candidate merchant location, server system 202 may provide a recommended merchant location. If the candidate merchant input data specifies a candidate merchant type, server system 202 may provide a recommended merchant type. Server system 202 may transmit the merchant recommendation data to client computing device 204. In some implementations, providing the merchant recommendation data includes providing a recommended merchant type for a candidate merchant location by providing a merchant type classification code (e.g., MCC or NAICS code). Also, in some implementations, providing the merchant recommendation data includes providing a recommended merchant type for a candidate merchant location based at least in part on a market opportunity value and/or a market saturation value associated with the candidate merchant location.

FIG. 9 is a diagram 900 of components of one or more example computing devices, for example, server system 202, that may be used in embodiments of the described systems and methods. FIG. 9 further shows a configuration of database 208 (FIG. 2). Database 208 is coupled to several separate components within server system 202, which perform specific tasks.

Server system 202 includes a storing component 902 for storing transaction data (e.g. transaction data section 916) for a plurality of model merchants within a memory (e.g., database 208). Server system 202 also includes a storing component 904 for storing model merchant data (e.g., model merchant data section 912) for each of the plurality of model merchants within the memory. Server system 202 additionally includes a generating component 906 for generating a location model (e.g., location model 914) by comparing the transaction data for each model merchant and the model merchant data for each model merchant. Additionally, server system 202 includes a receiving component 908 for receiving candidate merchant input data for a candidate merchant. Additionally, server system 202 includes an providing component 910 for providing, based on the location model and the candidate merchant input data, merchant recommendation data for the candidate merchant, wherein the merchant recommendation data includes at least one of a recommended merchant location and a recommended merchant type.

In an example embodiment, database 208 is divided into a plurality of sections, including but not limited to, a model merchant data section 912, a location model 914, and a transaction data section 916. These sections within database 208 are interconnected to retrieve and store information in accordance with the functions and processes described above.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 405, 504, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

The above-described embodiments of a method and system of identifying a merchant type or a merchant location for a candidate merchant provide information to merchants, commercial property owners, and other parties on what type of merchant would be likely to succeed in a given location and, similarly, what geographic region or location a given type of merchant would be likely to succeed in. As a result, parties involved in commercial property, such merchants, commercial property owners, and municipalities (i.e., through zoning and tax incentives) are able to make more informed choices on the placement and types of merchants within a region than with known systems and methods.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for providing merchant recommendation data based on candidate merchant input data, said method implemented using a computing device in communication with a memory, said method comprising:
storing transaction data for a plurality of model merchants within the memory;
storing model merchant data for each of the plurality of model merchants within the memory, wherein the model merchant data includes geographic attributes associated with each of the model merchants;
generating a location model by comparing the transaction data for each model merchant and the model merchant data for each model merchant;
receiving candidate merchant input data for a candidate merchant; and
providing, based on the location model and the candidate merchant input data, merchant recommendation data for the candidate merchant, wherein the merchant recommendation data includes at least one of a recommended merchant location and a recommended merchant type.

2. The computer-implemented method of claim 1, wherein storing model merchant data further comprises associating a merchant type classification code with each model merchant.

3. The computer-implemented method of claim 1, wherein the candidate merchant input data includes a candidate merchant location, and providing the merchant recommendation data further comprises providing a recommended merchant type.

4. The computer-implemented method of claim 1, wherein the candidate merchant input data includes a candidate merchant type, and providing the merchant recommendation data further comprises providing a recommended merchant location.

5. The computer-implemented method of claim 1, wherein the candidate merchant input data includes a candidate merchant location and providing the merchant recommendation data further comprises providing a recommended merchant type based at least in part on a market saturation value associated with the candidate merchant location.

6. The computer-implemented method of claim 1, wherein the candidate merchant input data includes a candidate merchant location and providing the merchant recommendation data further comprises providing a recommended merchant type based at least in part on a market opportunity value associated with the candidate merchant location.

7. The computer-implemented method of claim 1, wherein generating the location model further comprises generating the location model for each model merchant associated with at least one specified geographic attribute.

8. The computer-implemented method of claim 1, wherein generating the location model further comprises generating the location model for each model merchant associated with at least one specified merchant type classification code.

9. The computer-implemented method of claim 1, wherein storing model merchant data further comprises storing demographic attributes associated with a respective region in which each model merchant is located.

10. The computer-implemented method of claim 1, wherein storing the model merchant data further comprises storing cardholder attributes associated with at least one cardholder involved in a transaction for each model merchant.

11. A computing device for providing merchant recommendation data based on candidate merchant input data, said computing device comprising a memory device and a processor coupled to said memory device, said computing device configured to:
store transaction data for a plurality of model merchants within said memory;
store model merchant data for each of the plurality of model merchants within said memory, wherein the model merchant data includes geographic attributes associated with each of the model merchants;
generate a location model by comparing the transaction data for each model merchant and the model merchant data for each model merchant;
receive candidate merchant input data for a candidate merchant; and
provide, based on the location model and the candidate merchant input data, merchant recommendation data for the candidate merchant, wherein the merchant recommendation data includes at least one of a recommended merchant location and a recommended merchant type.

12. The computing device of claim 11, wherein said computing device is further configured such that storing model merchant data further comprises associating a merchant type classification code with each model merchant.

13. The computing device of claim 11, wherein the candidate merchant input data includes a candidate merchant location and said computing device is further configured such that providing the merchant recommendation data further comprises providing a recommended merchant type.

14. The computing device of claim 11, wherein the candidate merchant input data includes a candidate merchant type and said computing device is further configured such that providing the merchant recommendation data further comprises providing a recommended merchant location.

15. The computing device of claim 11, wherein the candidate merchant input data includes a candidate merchant location and said computing device is further configured such that providing the merchant recommendation data further comprises providing a recommended merchant type based at least in part on a market saturation value associated with the candidate merchant location.

16. The computing device of claim 11, wherein the candidate merchant input data includes a candidate merchant location and said computing device is further configured such that providing the merchant recommendation data further comprises providing a recommended merchant type based at least in part on a market opportunity value associated with the candidate merchant location.

17. The computing device of claim 11, wherein said computing device is further configured such that generating the location model further comprises generating the location model for each model merchant associated with at least one specified merchant type classification code.

18. The computing device of claim 11, wherein said computing device is further configured such that storing model merchant data further comprises storing demographic attributes associated with a respective region in which each model merchant is located.

19. The computing device of claim 11, wherein said computing device is further configured such that storing the model merchant data further comprises storing cardholder attributes associated with at least one cardholder involved in a transaction for each model merchant.

20. A computer-readable storage medium having computer-executable instructions embodied thereon, wherein when executed by a computing device having at least one processor in communication with a memory, the computer-executable instructions cause the computing device to:
store transaction data for a plurality of model merchants within the memory;
store model merchant data for each of the plurality of model merchants within the memory, wherein the model merchant data includes geographic attributes associated with each of the model merchants;
generate a location model by comparing the transaction data for each model merchant and the model merchant data for each model merchant;
receive candidate merchant input data for a candidate merchant; and
provide, based on the location model and the candidate merchant input data, merchant recommendation data for the candidate merchant, wherein the merchant recommendation data includes at least one of a recommended merchant location and a recommended merchant type.
